(19) United States
(12) Patent Application Publication
(10) Pub. No.: US 2021/0398039 A1
(43) Pub. Date: Dec. 23, 2021

(54) SYSTEM AND METHOD FOR CONFIGURING ENTERPRISE PERFORMANCE MECHANISMS

(71) Applicant: FUJIFILM Business Innovation Corp., Tokyo (JP)

(72) Inventors: Scott Carter, San Jose, CA (US); David M. Hilbert, Palo Alto, CA (US); Kandha Sankarapandian, San Jose, CA (US); Kazuki Ishikawa, San Jose, CA (US); Yasha Z. Spong, Oakland, CA (US); Ram Sriram, Saratoga, CA (US); Laurent Denoue, Verona (IT); Shinji Onishi, Tokyo (JP)

(21) Appl. No.: 16/904,465

(22) Filed: Jun. 17, 2020

(51) Int. Cl. G06Q 10/06

(52) U.S. Cl. CPC G06Q 10/0639

(57) ABSTRACT

A computer-implemented method, comprising obtaining an input associated with historical information, deadlines, and user-related information, or information associated with historical tasks, current tasks and user metadata; performing a calculation on the input to generate an output; and based on the output, generating a timing of a campaign and a team composition, or task lists and point values.

### BACKGROUND

### Field

Aspects of the example implementations relate to methods, systems and user experiences associated with configuring enterprise performance mechanisms, and more specifically, to process input information for generation of a performance campaign and task-based gamification.

### Related Art

In the related art, enterprise departments that deal with cash flow in and out of businesses must address inefficiencies, including issues with processing transaction documents such as purchase orders and invoices, review and approval of forms, discount capture and fee avoidance, etc. The enterprise departments may also face challenges in the related art with respect to understanding the cost-benefit tradeoff of integrating their customers and suppliers into a digital workflow.

To address these related art concerns, motivational campaigns can be used to help focus workers on productive goals. However, there is a problem or disadvantage in the related art with respect to using this approach, because managers must create and configure these techniques manually.

Related art enterprises deploy a variety of approaches to focus the efforts of workers and teams to meet manager-specified goals. These approaches generally fall into two broad categories: motivational campaigns, such as contests, to engage workers and teams to achieve desired goals in a given amount of time, and task lists to encourage workers to complete a set of tasks that compose one or more activities.

As explained above, related art approaches to creating motivational campaigns is largely manual. More specifically, managers must determine that a given metric for a team or individual has fallen below a desired level and is a good candidate for an intervention. Managers must also determine the right type of campaign (e.g., a contest or challenge) and specify incentives for a given intervention. If the mechanism involves creating teams of workers, the manger must determine the best blend of personnel for each team. Finally, the manager must specify rewards for specific activities.

Related art task management, on the other hand, requires manually decomposing an activity into a set of tasks for workers to perform. Such related art approaches lack integrated motivational mechanisms.

In the related art, the many decisions involved in creating, configuring, and managing motivational campaigns and task lists places an enormous burden on managers hoping to deploy motivational strategies in the workplace.

There is an unmet need in the related art to develop an automated or semi-automated solution to help a managers deploy motivational strategies in the workplace.

### SUMMARY

According to an aspect of the example implementations, comprising obtaining an input associated with historical information, deadlines, and user-related information, or information associated with historical tasks, current tasks and user metadata; performing a calculation on the input to generate an output; and based on the output, generating a timing of a campaign and a team composition, or task lists and point values.

Example implementations may also include a non-transitory computer readable medium having a storage and processor, the processor capable of executing instructions associated with configuring enterprise performance mechanisms, and more specifically, to process input information for generation of performance campaign and task-based gamification.

### BRIEF DESCRIPTION OF THE DRAWINGS

The details of embodiments of the present disclosure, both as to their structure and operation, can be gleaned in part by study of the accompanying drawings, in which like reference numerals refer to like parts, and in which:

FIG. 1 is a functional block diagram of an example implementation;

FIG. 2 is a functional block diagram of an example implementation;

FIG. 3 is an example user experience;

FIGS. 4A and 4B are flowcharts of an example implementation of a method according to the disclosure;

FIG. 5 is a functional block diagram of an example implementation of a computing environment according to the disclosure; and

FIG. 6 is a functional block diagram of an exemplary operating environment according to the disclosure.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting.

The present example implementations provide a system that semi-automatically creates and configures motivational campaigns for managers, and recommends specific tasks to workers. More specifically, the system analyzes past and current worker performance, effort, and completing tasks. The system also recommends motivational campaigns to managers, at times when performance is not meeting the desired performance levels. Further, the system provides a recommendation on how to organize participants, including team composition, based on inputs such as past worker performance, skills and demographic data.

Additionally, the system is configured to provide a recommendation of a motivational approaches, based on past performance of various motivational mechanisms, such as those associated with similar tasks, using similar participants or the like. Accordingly, the system may prioritize and appropriately incentivize specific actions for workers, based on an analysis of an effort and impacts of past tasks, as well as and expected effort and impact of current tasks.

Aspects of the example implementations are directed to smart motivational campaigns and gamified task lists that ameliorate these issues, with applications in enterprise accounts payable and accounts receivables departments as well as other departments. According to the example implementations, smart motivational campaigns and gamified task lists can be used individually or in combination. Smart motivational campaigns may include system-driven recommendations as to when to run campaigns, how to configure them, and how to prioritize and incentivize tasks. Further, the determination may be based on data associated with performance, deadlines/goals (e.g., individual or group goals), employee skills/demographics, expected effort and impact, etc. Gamified task lists may include prioritized task lists with incentives scaled by expected effort and impact.

For example but not by way of limitation, contests involving complicated activities (e.g., those that involve many tasks) can be connected with gamified task lists to help individual workers select specific tasks to complete to best help their team. This example approach may involve deciding when to start a campaign, choosing participants, and selecting incentives and desired behaviors. Moreover, recommendation-based methods are provided for creating and configuring these types of motivational mechanisms semi-automatically.

To obtain the information for the example implementations, mining of past worker performance and known skills and demographics is combined with known target dates to recommend the timing and structure of motivation mechanisms. For example and not by way of limitation, enterprise settings used in the example implementations may include but are not limited to objective performance data (e.g., time-to-completion), subjective performance data (e.g., manager ratings of task-based ability and skills), standard demographic data (e.g., gender, age, whether the worker is remote, etc.), and client or internal deadlines.

As explained above, the example Asians include two aspects that may act independently: creating motivational campaigns such as contests for individuals and teams, as well as gamified task lists for individuals.

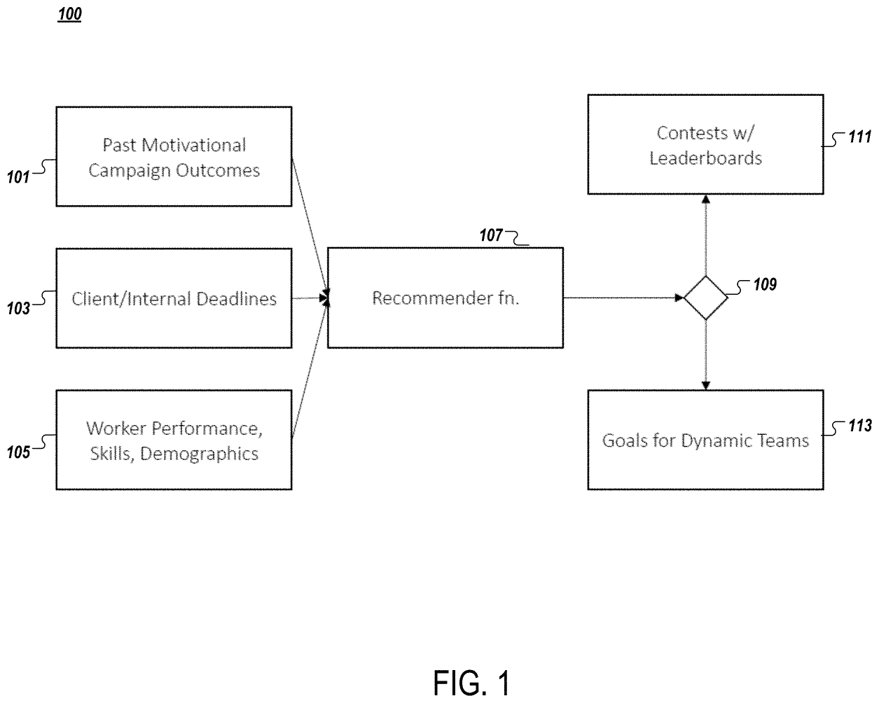

FIG. 1 illustrates a functional diagram of smart motivational campaigns according to the example implementations. More specifically, various inputs are provided to a recommender function, which in turn provides output recommendations and content to assist (e.g., assist managers) in the construction of a smart motivational campaign. For the smart motivation campaign, the present example implementations use inputs (e.g., worker data) to analyze task performance in real-time, to detect an optimal timing to deploy a new contest.

For example, a determination may be made that a given group is not projected to meet a known deadline for a given client or compliance issue, and send a recommendation to the manager of that group to launch a new motivational campaign. The example implementations may determine, from past performance of team members, what type of campaign might be most appropriate.

For example but not by way of limitation, one group of workers might have responded better in the past to ranking-based mechanisms that pit team members against one another, whereas another group might have fared better with mechanisms that split members into separate teams that compete against each other or with a pre-specified target. For the latter case, targets may be chosen that are one standard deviation above the median of the team members' previous score, as an incentive.

Further, the example implementations may also generate inferences from workers' past performance to generate a recommendation (e.g., for a manager) of an optimal blend of workers for a team. This approach may follow a simple feature-weighting approach to create teams. For example, managers may try to ensure that teams include a mix of high- and low-performing workers on them. If the data is available, the approach may incorporate demographics, such as worker age and gender to create blended teams.

In terms of the inputs, historical information, such as outcomes of past motivational campaigns is provided at 101. Further, at 103, information associated with due dates or deadlines, including internal and client facing external, or provided. Further, information associated with the members who will be the participants in the smart motivational campaign, such as worker performance, skills, demographics, etc. is provided at 105.

The inputs, including 101, 103, 105, are provided to a recommender function 107. The recommender function performs a process on those inputs to generate a recommendation. The recommendation is provided to an output function 109, which in turn transforms the recommendation into appropriate output for contests with leaderboard 111, and goals for dynamic teams 113.

Accordingly, based on this example implementation, the timing and structure of motivational campaigns, such as contests and challenges is recommended, based on the inputs, including historical data, target dates, and worker information such as performance, skills and demographics.

For the foregoing example implementation, an example smart motivational campaign is provided as follows. As for the inputs, the current conditions of the organization are provided. For example, in the current conditions, 20% more invoices are expected to be processed during the present period as compared with the last period, by the accounting department. Further, the accounting team, in a past motivational campaign, completed processing of 85% of the invoices within the target timing, which was a 15% increase over their mean processing time. Further, with respect to information on the participants, worker performance is provided with respect to employee John, who exceeded his target on invoices trained by 20%, on average, during the past three periods. Additionally employee Maru underperformed his target on invoices trained by 10% during the past three periods, on average.

The above described example inputs for the example smart motivational campaign are applied to the recommender function 107, which performs computations. For example, but not by way of limitation, given the current target conditions and the outcomes of past motivational campaigns, the recommender function 107 calculates a risk of not hitting the target invoice processing time. Further, the recommender function 107 determines that the visible leaderboard improves the performance of the accounting team. The recommender function 107 then estimates the target processing time required to handle the increased load of 20% more invoices that was input.

With respect to the worker performance information, the recommender function 107 creates a dynamic team, including John and Maru. Further, the recommender function 107 performs a computation of estimating a target that is one standard deviation above the combined average of the invoices trained in the past three periods for John and Maru.

Based on the foregoing computations of the recommender function 107, and output is generated to element 109. More specifically, a recommendation is generated to conduct an invoice processing contest for the accounting team, to handle the increased load. Further, a recommendation is provided to conduct an invoice training challenge for John and Maru, to provide a leading indicator of a capability to handle load in the future.

As an example implementation associated with the foregoing embodiments, task-specific operations and calculations may be performed as follows.

According to an example use case, the contest recommendations may be generated as follows. A service (S) detects a change in a monitored metric (Mₖ) such as Invoice arrival rate, Invoice approval times, etc. Service S then retrieves information associated with past outcomes (O_{c}) on campaigns for Mₖ to identify timing and structure that effected positive change. Then, Service S computes the effort required, and scaled points for tasks completion (Pₜ), to process the change in Mₖ. Accordingly, Service S recommends contest timing and structure (Cₖ) to a Manager to approve. Upon approval, Service S notifies Cₖ's details to its participants, and S initiates the Campaign on schedule and on completion, and appends the results to O_{c}.

In the foregoing example, the goals determination is performed as follows. The Service (S) looks up past outcomes (O_{g}) on individual goals (I_{g}) around a particular metric (Mₖ) for participants (N. The Service S then recommends a dynamic team (Tₖ) consisting of members (P_{1 . . . n}) where some Pᵢ reached the goal and some Pᵢ missed the goal and a scaled team goal (T_{g}) for the dynamic team to achieve to a Manager to approve. Upon approval, S notifies Tₖ members about T_{g}. Further, Service S tracks progress against T_{g} for the goal period, and appends the results to O_{g}.

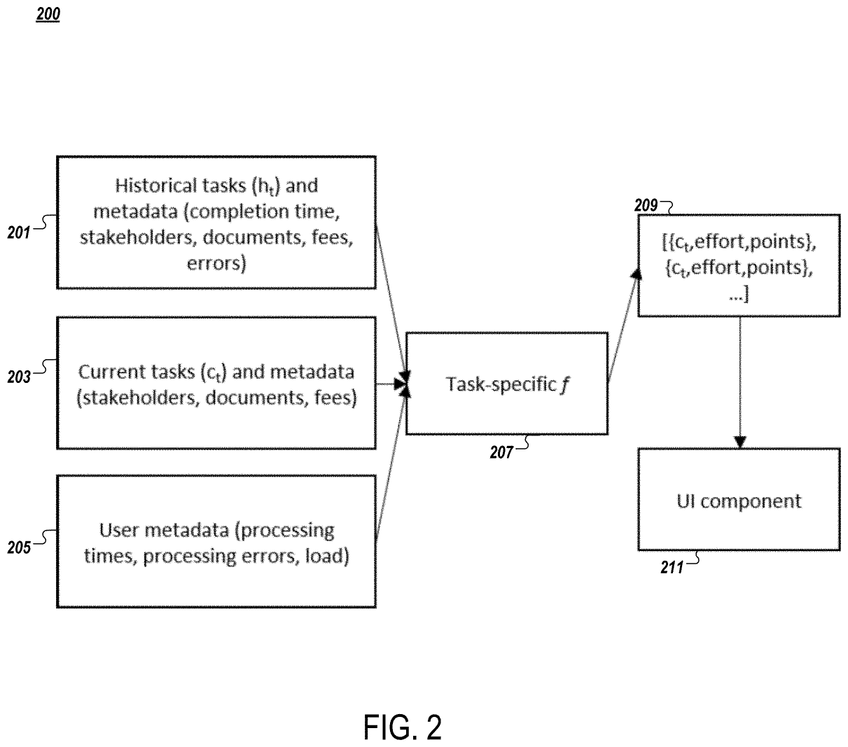

FIG. 2 illustrates an example functional diagram 200 of gamified task lists according to the example implementations. According to this example implementation, a plurality of inputs are provided to a recommender function that generates outputs. Specific tasks are recommended to workers that help them complete a given activity. In this case, task recommendations may be sent directly to workers, who take on certain tasks in order to earn points. Workers may earn points to compete for specific prizes, as well as to compete against others in the organization. Points may be scaled based on the impact/outcome of completing the recommended tasks. Impact can be measured in terms of time saved (e.g., # of invoices automated), money saved (e.g., monetary value of discounts captured or fees avoided), etc. The combination of tasks and points can be structured to optimize the overall system's performance.

In the example gamified task list approach, tasks are recommended to workers using a domain-specific function that takes as input a user and their associated meta-data, a set of completed (historical) tasks, and a set of new tasks to perform. The function outputs a set of {task, effort, points} objects for each user in the system. The task-specific function may consider current user load to limit the total number of tasks shown to the worker, or filter tasks by level of effort. Complicated tasks may be expanded into their own gamified list of underlying operations.

Further details of the example functional diagram 200 and the example are disclosed below. More specifically, the example implementations employ a domain specific function that receives, as it inputs, a user and associated metadata of the user, a historical sense of completed tasks, and a set of new tasks to be performed. The function receives those inputs, and outputs a set that includes task, effort and points as objects for users in the system.

With respect to the inputs, at 201, historical tasks and metadata are provided. For example but not by way of limitation, for a given historical task hₜ, the associated metadata may include, but is not limited to, completion time, stakeholders, documents, fees and errors.

Additionally, at 203, current tasks and associated metadata to be performed are provided as inputs. For example if not by way of limitation, for a given current tasks to be performed cₜ, the associated metadata may include, but is not limited to stakeholders, documents and fees.

Further, as an additional input at 205, metadata associated with the user is provided. For example, but not by way of limitation, user metadata may include processing times, processing errors and a load for a given user.

At 207, the inputs 201, and 205 are processed by function, which is a task specific function, to generate output. Further details of the function are provided below in the form example associated with this process.

At 209, for each task t, and output set is generated. The output set includes the task, the associated effort, and the points that are associated with the task and the effort. At 211, a user interface component is generated for the user.

With respect to the foregoing example implementation of the gamified task list, an example is provided as follows. As an input, the current tasks are provided. For example but not by way of limitation, a first task is to retrain the system to fix recognition errors in a first form A. A second task is to train the system to automatically recognize a second form B. As an input, historical data is provided. The historical data identifies the completion rate for similar tasks, as well as the benefits to the company.

For the given inputs, the function 207, performs one or more computations. In the present example, those computations may include computing an estimated effort to complete the tasks. For example, but not by way of imitation, the function may look to tasks having a similar type and a similar number of fields to calculate the estimation. Additionally, in the present example, a number of points to be awarded may be estimated, based on the benefit to the company. For example, a number of expected forms may be used to derive a benefit, and based on the benefit determine the number of points to be awarded for the game.

Based on the foregoing computations, with respect to the current tasks, outputs are generated for the user in an interface. For example, but not by way of limitation, if a determination is made that the estimated effort of the first task is 10 minutes and the estimated effort of the second task is 30 minutes, then based on the benefit to the company, the first task may be awarded 10 points, and the second task may be awarded 100 points.

As an example implementation associated with the foregoing embodiments, task-specific operations and calculations may be performed as follows.

The task-specific function outputs a sorted list of tasks for the current user based on a rank for each task. The rank is a combination of effort and points for the task:

Rₜ=1/Eₜ*Pₜ

Where effort is defined as the historical average of the time (T) and effort (E) the current user took to accomplish similar tasks plus the current user load (UL) and possibly other factors:

E₁= [symbol] ˜Tₜ [symbol] + [symbol] ˜Eₜ [symbol] +ULₜ+ . . .

Where points are defined as the historical average of fees (F) recovered by the company for the given task as well as the current stakeholder priority (SP), manual weights for a given task (M, e.g., determined by a manager) and possibly other factors:

Pₜ= [symbol] ˜Fₜ [symbol] +SPₜ+Mₜ

Where the similarity of tasks is determined by a lookup table comparing the current tasks' description, documents, and stakeholders.

The foregoing task-specific function is just one example of a task-specific function. Other task specific functions may be added for other tasks, as would be understood by those skilled in the art.

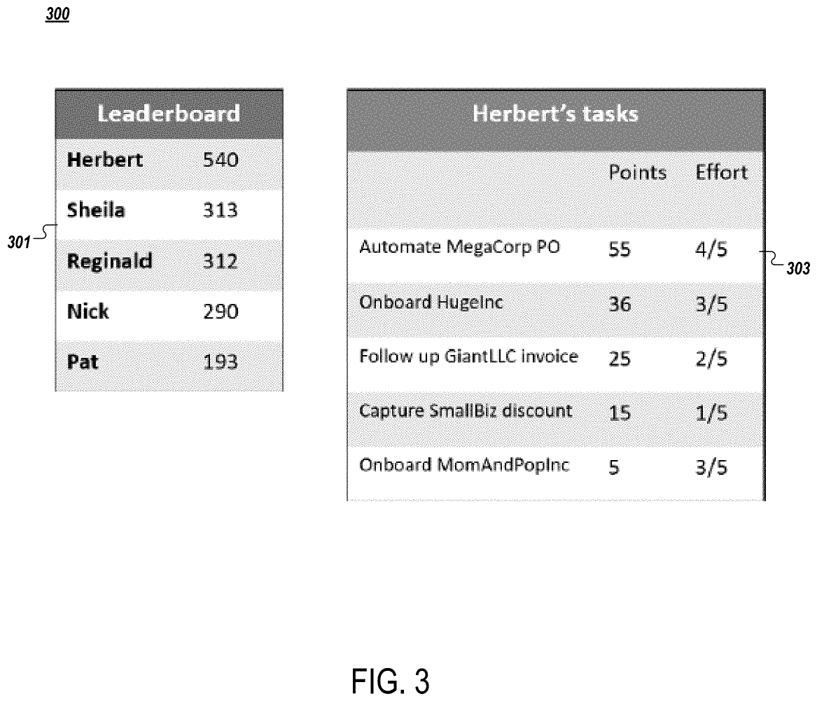

FIG. 3 illustrates various example user experience is associated with the foregoing example implementations 300. For example and not by way of limitation, and overall leaderboard 301 provides an illustration of a number of points earned by each of the participants in the campaign, as compared with one another. Additionally, at 303, a user interface for a particular user is illustrated. More specifically, in the specific users view 303, the particular user can see a list of the tasks, as well as the points earned and the determined efforts associated with each of those tasks.

While some of the example implementations may only require managers to notify workers to complete straightforward activities that need not be deconstructed into tasks, such as instructing workers to obtain new customers within a prescribed time period, other tasks are more complex. For such complex activities, where various deconstructed tasks are included, the gamified list feature may be used by managers to prioritize tasks.

For example but not by way of limitation, a manager may semiautomatically create a contest to encourage workers to automate backend services. The gamified lists may be used to recommend specific tasks for workers to meet this activity's goal, such as automating a particular form or writing a script to connect two parts of the system that currently require manual editing to merge.

The foregoing example implementations may be employed in various scenarios. While the present example implementations are not limited thereto, some examples of scenarios are described as follows. The activities are explained in the context of enterprise accounts payable and enterprise accounts receivable for illustrative purposes only. These activities may be part of either a specific campaign or simply part of an organizations' regular practices.

According to a first example automation of forms may be increased. Converting manual entry and analysis to automated processing is a method for improving the throughput of enterprise accounting systems. These systems ingest forms, both digital and physical, automatically detect values and labels for each field, and inject values into a backend, digital workflow. However, these systems may depend on learning algorithms that require manually labeled data, and use a variety of different forms, such that scanning errors may cause recognition errors. Therefore, human experts assist to correctly process forms, especially when the system has not yet processed a particular form type.

Applying the foregoing example implementations, the gamified list may encourage workers processing invoices to focus on the most important forms to train (e.g., currently non-automated) or retrain (e.g., automated but with recognition errors). The above-described recommendation function of the example implementation receives as inputs the set of all forms previously processed and the overall number of automation errors associated with each previously processed form, as well as the set of all forms waiting to be processed.

For each form in the queue, the above-described recommendation function creates a {task, effort, points} object, where the task is training the system for the given form, the effort is equal to the number of fields (for new forms) or average number of fields with recognition errors (for previously trained forms) multiplied by the typical time to complete those fields, and the points is equal to the effort multiplied by the rate at which the form is processed. The system then creates a ranked recommendation list of tasks for the user sorted by effort, points, or a combination of both.

When the user completes a task, they are rewarded with the calculated number of points for that task. The points a user accumulates for training or retraining a form can optionally be adjusted over time based on the frequency with which the trained form is automatically processed in the future, which is particularly useful when the user trains a new form that has not been encountered.

According to another example, the example implementations may be applied to onboarding customers and suppliers to a digital workflow, such as which customers/suppliers should be onboarded (e.g., converted from paper-based processing to digital processing). The input may include the set of forms related to each vendor and the output may include a list of {task, effort, points} sets where each task is onboarding a particular vendor, effort is equal to the difficultly in converting a vendor from paper to digital (which might vary based on how often the vendor has submitted paper versus digital forms in the past), and points is equal to the likely time saved in the future.

According to a further example, the example implementations may be applied to increasing discount capture and fee avoidance, to optimize cashflow by capturing as many early-payment discounts as possible while limiting late-payment fees and maintaining positive cashflow. For this example, the input is the historical set of payments, the expected cash flow, and the set of current payments with associated early-payment discounts and late-payment fees. The output is a set of {task, effort, points}, where each task is a payment, the effort corresponds to the difficulty of executing the task within the time required to capture the discount or avoid fees, and points correspond to the value of capturing a discount and/or avoiding a fee scaled by the amount of the discount or fee. For example, if data from another source is included that indicates that a large account receivable is reliably incoming, then then discount for early payment of an account payable may be made.

According to still another example, the example implementations may be used for increasing speed of purchase and payment processing tasks. A costly issue with enterprise accounting systems comes from delays in common processing tasks, such as purchase request approval, purchase order placement, invoice verification, and payment approval. The foregoing example implementations may be employed to increase the efficiency of these processes.

If the inputs include a record of previous processing tasks as well as the stakeholders involved, the output may include a {task, effort, points} set where each task is a set of (predetermined) subtasks that can be performed to hasten a particular task, effort is how difficult it is to perform each subtask, and points corresponds to the relative improvement in processing time for the given task.

For example, the system might detect that an invoice verification that involves a particular manager typically takes longer than other invoices and recommend to the user that they send regular notifications to the relevant manager to ensure that the invoice is verified in a timely manner.

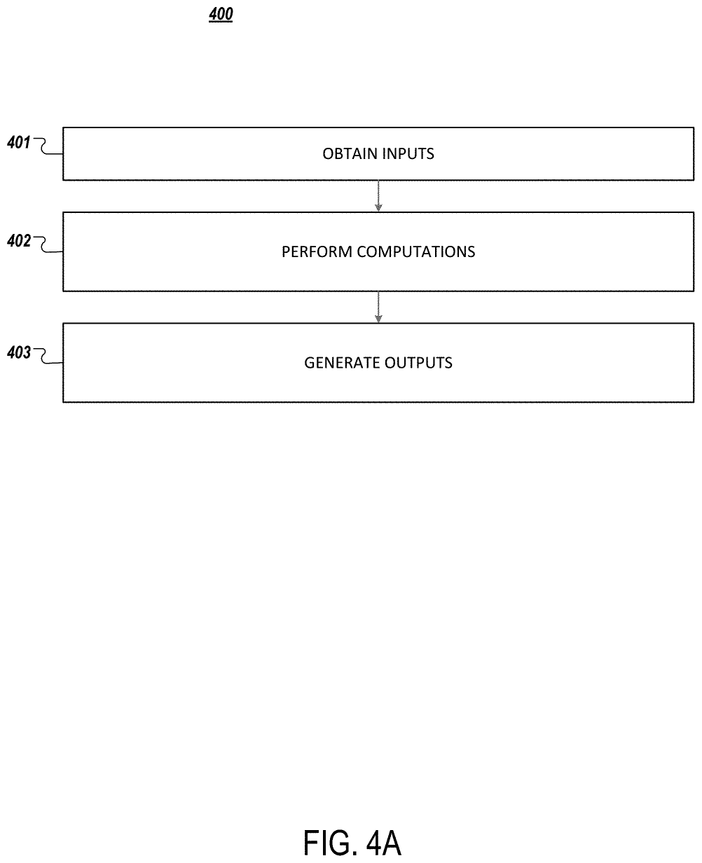

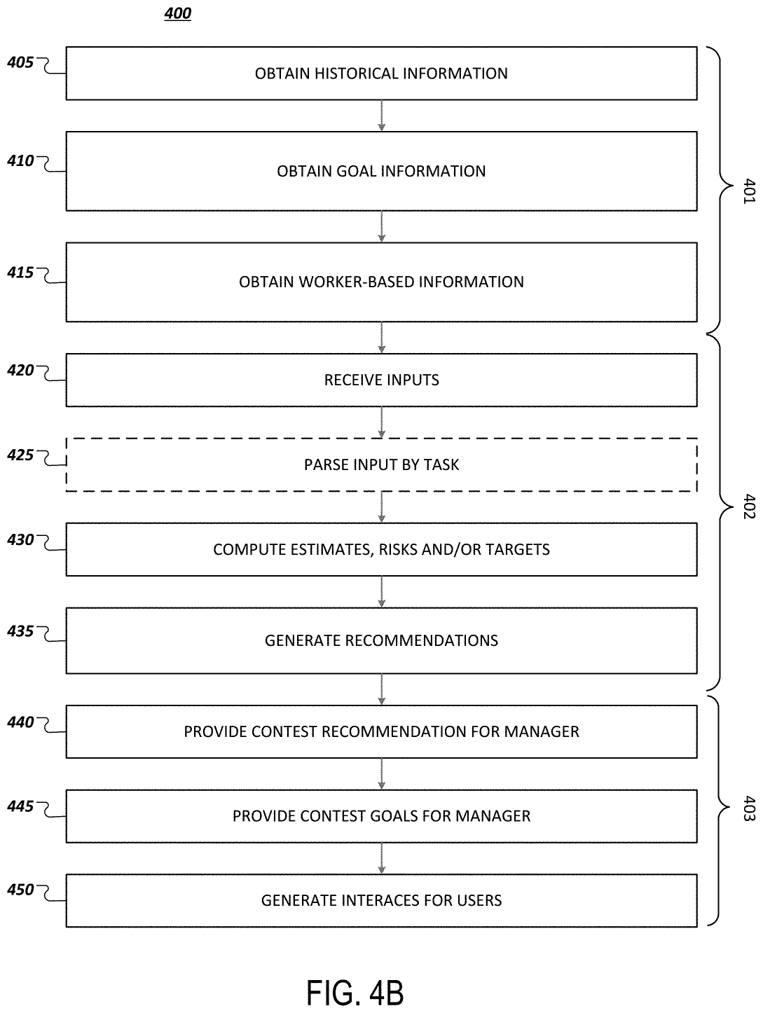

FIGS. 4A and 4B are a flowcharts of an embodiment of a method for according to the disclosure. A method 400 can be implemented by one or more processors in a computing environment (e.g., the computing environment described below). As shown in FIG. 4A, the method 400 can be a combination of multiple sub processes, including at 401, obtaining an input associated with, for the smart campaign example implementation, past motivational campaign outcomes, client/internal deadlines, and worker-related information such as performance, skills and demographics, and for the gamification example implementation, information of historical tasks, current tasks and user metadata. At 402 computation is performed by receiving the inputs as obtained in operation 401, to generate relevance recommendations and/or interfaces. At 403, outputs are generated, such as a recommended timing of the campaign, team formation, task lists, point values, etc. The specific details of the foregoing operations 401-403 are disclosed above and with respect to the description of FIGS. 1-3.

In more detail, FIG. 4B illustrates an example process associated with the present example implementations. While the operations described herein are sequenced according to the drawings, the present plantations are not limited thereto. For example, the sequence of operations may be changed, and operations may be combined, separated or deleted, without departing from the inventive scope.

The information obtaining process 401 is illustrated in operations 405-415. More specifically, at 405 historical information is obtained. For example, but not by way of limitation, the historical information may include past campaign results, and/or historical task information such as completion time, stakeholders, documents, errors, and fees, etc.

At 410, goal information is obtained. For specifically, information associated with internal deadlines, external or client facing deadlines, or other metrics associated with the timing of the campaign, may be obtained. Similarly, information associated with current tasks and the related metadata, such as stakeholders, documents and fees, may also be obtained.

At 415, worker-based information may be obtained. For example not by way of limitation, information associated with worker performance, skills and/or demographics may be obtained. Further, user metadata associated with task completion, such as processing times, processing errors or load, may also be obtained.

As explained above, the information obtaining process 401 may be performed. Some or all of the information disclosed above with respect to the present example implementations may be obtained. The obtained information is used to perform operations at 402, as explained below with respect operations 420-435.

At 420, the obtained inputs of the input obtaining process 401 are received.

Optionally, at 425, the receive inputs may be parsed by task, in the case of plural tasks. For the circumstance where there is only a single task, or in the case of a smart campaign example implementation, operation 425 may be omitted.

At 430, computations are performed based on the inputs as explained above. For example but not by way of limitation, computations associated with risks, estimates, timelines, and/or targets may be computed.

At 435, recommendations are generated. For example but not by way of limitation, the recommendations may include a timing of a campaign, a composition of a team on the campaign, the generation task lists, information on points associated with tasks for a game, or others as disclosed above.

Thus, as explained above, the operation of 402 associated with computation is performed. Outputs of operation 402 are used in the output generation operation 403, as explained below with respect to operations is 440-450.

At 440, a contest recommendation is provided, such as for a manager. More specifically, the recommendation may include information about a timing of the campaign, team composition for the campaign, goals recommended as an outcome of the campaign or other recommendations as explained herein.

At 445, contest goals are provided. For example, a goal for the metrics of performance may be provided to the manager, as explained above.

At 450, interfaces may be generated for the users. As explained above and as illustrated in FIG. 3, the users may be able to see a scoreboard, or an individual user may be able to see the details of his or her score.

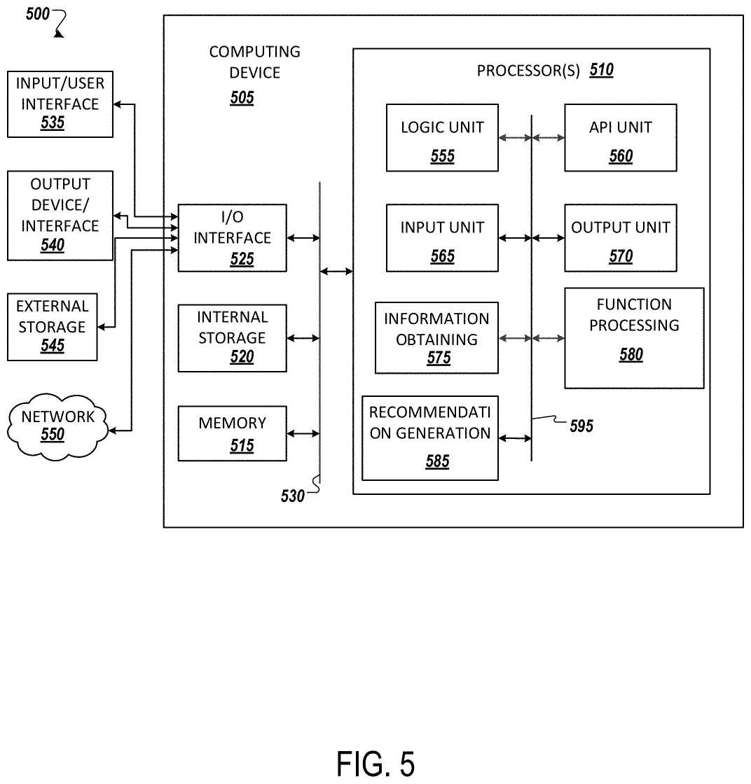

FIG. 5 is a functional block diagram of an embodiment of a computing environment according to the disclosure. A computing environment 500 with an example computer device 505 suitable for use in some example implementations. Computing device 505 in computing environment 500 can include one or more processing units, cores, or processors 510, memory 515 (e.g., RAM, ROM, and/or the like), internal storage 520 (e.g., magnetic, optical, solid state storage, and/or organic), and/or I/O interface 525, any of which can be coupled on a communication mechanism or bus 530 for communicating information or embedded in the computing device 505. The environment 500 can support operations associated with the system 100, for example.

According to the present example implementations, the processing associated with the neural activity may occur on a processor 510 that is the central processing unit (CPU). Alternatively, other processors may be substituted therefor without departing from the inventive concept. For example, but not by way of limitation, a graphics processing unit (GPU), and/or a neural processing unit (NPU) may be substituted for or used in combination with the CPU to perform the processing for the foregoing example implementations.

Computing device 505 can be communicatively coupled to input/interface 535 and output device/interface 540. Either one or both of input/interface 535 and output device/interface 540 can be a wired or wireless interface and can be detachable. Input/interface 535 may include any device, component, sensor, or interface, physical or virtual, which can be used to provide input (e.g., buttons, touch-screen interface, keyboard, a pointing/cursor control, microphone, camera, braille, motion sensor, optical reader, and/or the like).

Output device/interface 540 may include a display, television, monitor, printer, speaker, braille, or the like. In some example implementations, input/interface 535 (e.g., user interface) and output device/interface 540 can be embedded with, or physically coupled to, the computing device 505. In other example implementations, other computing devices may function as, or provide the functions of, an input/interface 535 and output device/interface 540 for a computing device 505.

Examples of computing device 505 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, server devices, other computers, information kiosks, televisions with one or more processors embedded therein and/or coupled thereto, radios, and the like).

Computing device 505 can be communicatively coupled (e.g., via I/O interface 525) to external storage 545 and network 550 for communicating with any number of networked components, devices, and systems, including one or more computing devices of the same or different configuration. Computing device 505 or any connected computing device can be functioning as, providing services of, or referred to as, a server, client, thin server, general machine, special-purpose machine, or another label. For example but not by way of limitation, network 550 may include the blockchain network, and/or the cloud.

I/O interface 525 can include, but is not limited to, wired and/or wireless interfaces using any communication or I/O protocols or standards (e.g., Ethernet, 802.11xs, Universal System Bus, WiMAX, modem, a cellular network protocol, and the like) for communicating information to and/or from at least all the connected components, devices, and network in computing environment 500. Network 550 can be any network or combination of networks (e.g., the Internet, local area network, wide area network, a telephonic network, a cellular network, satellite network, and the like).

Computing device 505 can use and/or communicate using computer-usable or computer-readable media, including transitory media and non-transitory media. Transitory media includes transmission media (e.g., metal cables, fiber optics), signals, carrier waves, and the like. Non-transitory media includes magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device 505 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 510 can execute under any operating system (OS) (not shown), in a native or virtual environment. One or more applications can be deployed that include logic unit 555, application programming interface (API) unit 560, input unit 565, output unit 570, information obtaining unit 575, function processing unit 580, recommendation generation unit 585, and inter-unit communication mechanism 595 for the different units (e.g., the encode 110 and the decoder 120) to communicate with each other, with the OS, and with other applications (not shown).

The information obtaining unit 575 can perform functions associated with receiving inputs, processing inputs, and obtaining further inputs; as explained above, the inputs may be different for the smart campaign and the gamified task list. The function processing unit 580 can perform functions associated with the processing of the inputs to produce an output; as explained above, the function processing may be different for the smart campaign and the gamified task list. The recommendation generation unit 585 can generate outputs for the manager and/or user, such as the recommendations, or an interface for the user; as explained above, the outputs may be different for the smart campaign and the gamified task list.

For example, the information obtaining unit 575, the function processing unit 580, and the recommendation generation unit 585 may implement one or more processes shown above with respect to the structures described above in addition to the method 600. The described units and elements can be varied in design, function, configuration, or implementation and are not limited to the descriptions provided.

In some example implementations, when information or an execution instruction is received by API unit 560, it may be communicated to one or more other units (e.g., logic unit 555, input unit 565, information obtaining unit 575, function processing unit 580, and recommendation generation unit 585).

In some instances, the logic unit 555 may be configured to control the information flow among the units and direct the services provided by API unit 560, input unit 565, information obtaining unit 575, function processing unit 580, and recommendation generation unit 585 in some example implementations described above. For example, the flow of one or more processes or implementations may be controlled by logic unit 555 alone or in conjunction with API unit 560.

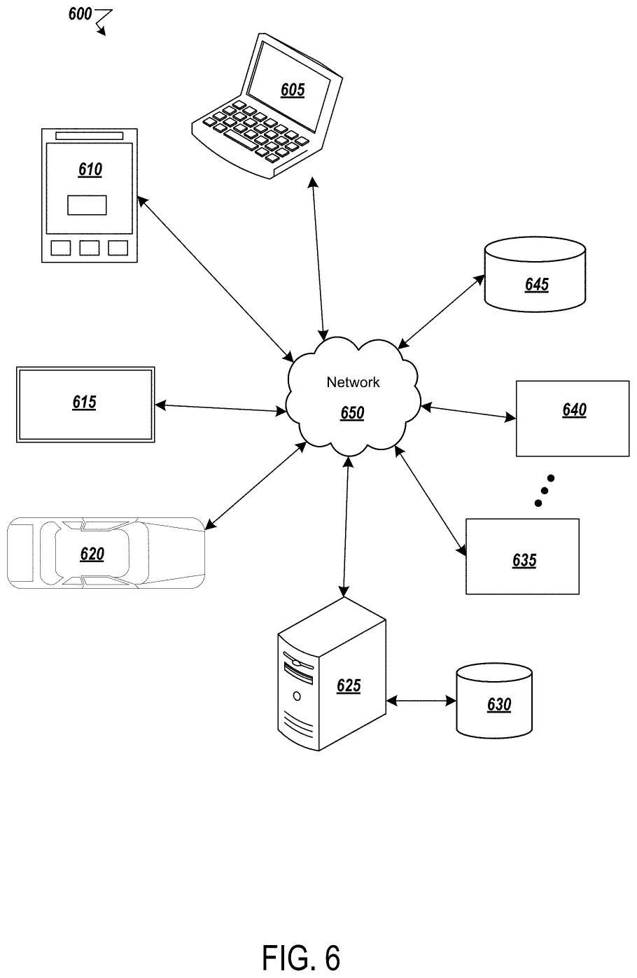

FIG. 6 is a functional block diagram of an exemplary operating environment according to the disclosure. An environment 600 can be suitable for some example implementations disclosed herein. Environment 600 includes devices 605-645, and each is communicatively connected to at least one other device via, for example, network 660 (e.g., by wired and/or wireless connections). Some devices may be communicatively connected to one or more storage devices 630 and 645.

An example of one or more devices 605-645 may be computing devices 505 described in FIG. 5, respectively. Devices 605-645 may include, but are not limited to, a computer 605 (e.g., a laptop computing device) having a monitor and an associated webcam as explained above, a mobile device 610 (e.g., smartphone or tablet), a television 615, a device associated with a vehicle 620, a server computer 625, computing devices 635-640, storage devices 630 and 645.

In some implementations, devices 605-620 may be considered user devices associated with the users, who may be remotely obtaining a sensed audio input used as inputs for the foregoing example implementations. In the present example implementations, one or more of these user devices 605-620 may be associated with one or more sensors such as microphones in a phone of a user or a POS device, that can sense information as needed for the present example implementations, as explained above.

The present example implementations may have various benefits and advantages with respect to the related art. Related art approaches may provide such features as recommendation of a game type based on a personality type of an individual. However, recommendations are not provided for campaign finding, team formation, task lists or the like.

Additionally, related art approaches may apply gamification to motivate staff to complete specific workflow tasks. However, those related art approaches do not provide recommendations for campaign timing, team formation or the like, based on different types of task prioritization. Similarly, game-based approaches for e-commerce websites to expedite payment collections failed to provide a concept of enterprise tasks, team formation or the like, including different types of task prioritization.

While related art approaches may provide generic game-based product forms with metrics, targets and achievements, those related art approaches do not provide recommendations for campaign timing, team formation, game-based task list or the like. Related art approaches that focus on sales, support and training, with integration into enterprise based solutions also failed to provide campaign timing, team formation and task list based game approaches or the like.

Thus, the present example implementations may have various benefits and advantages. For example but not by way of limitation, the present example limitations provide a combination of inputs that may include but are not limited to demographics and skills of workers, worker performance, campaign outcomes, historical and deadlines or other measures of performance. Further, the present example implementations provide a combination of outputs that may include but are not limited to timing and type of campaign as an automation, team formation, goal setting, task prioritization and point scaling, as a result of one or more computations performed by a function.

In addition to the foregoing example implementations, the present inventive concept is not limited thereto and may be used in additional environments or approaches. For example, not by way of limitation, all of the foregoing example in patients refer to the recommendation being provided to a manager for the purpose of improving team performance, the roles may not be limited to a manager. Other stakeholders or decision-makers, such as executives, human resources department, information technology department, or other operational functions of an organization the approaches described herein to improve the performance of a team of members having a measure of performance.

Additionally, while the game-based model is shown as providing an incentive to improve productivity, using points, incentives other than points may be substituted without departing from the scope. For example the not by way of limitation, performance management compensation systems may be integrated with the points in the foregoing example implementations, to provide for the determination of monetary rewards. Further, automatically determined points may be manually adjusted, based on the preference of the decision-maker, to account for situations where extra motivation is desired for specific tasks or activities.

Further, while the foregoing inputs have been provided, other inputs may also be provided, or substituted therefor, without departing from the scope. For example and not by way of limitation, additional information may be obtained as inputs or use in the recommendation function. According to one example implementation, natural language processing may be performed on communications, such as those between a buyer and a supplier or a customer vendor, to generate additional information. In one such example, a term such as “expected incoming payments” may be inferred, based on conversations, and then be incorporated into cash flow related task recommendations.

According to another example implementation, motivational mechanisms may be adjusted based on human behavior analysis. More specifically, the human behavior may be measured, and motivational mechanisms may be advance, either an individual or team level, to associate the reward with behavior historical information necessary to reach the desired goal.

Further, the example implementations may be employed in scenarios where productivity changes. For example, where users transition from an office workspace to a remote workspace, such as working from home, the present example implementations may permit for the use of campaigns or gamification to increase workflow rather than constant monitoring of the remote worker. The present example implementations may also be used in other environments, such as manufacturing training, quality control, or the like.

Although a few example implementations have been shown and described, these example implementations are provided to convey the subject matter described herein to people who are familiar with this field. It should be understood that the subject matter described herein may be implemented in various forms without being limited to the described example implementations. The subject matter described herein can be practiced without those specifically defined or described matters or with other or different elements or matters not described. It will be appreciated by those familiar with this field that changes may be made in these example implementations without departing from the subject matter described herein as defined in the appended claims and their equivalents.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

What is claimed is:

1. A computer-implemented method, comprising:
obtaining an input associated with historical information, deadlines, and user-related information, or information associated with historical tasks, current tasks and user metadata;
performing a calculation on the input to generate an output; and
based on the output, generating a timing of a campaign and a team composition, or task lists and point values.

2. The computer-implemented method of claim 1, wherein,
the historical information comprises past campaign results, the user-related information comprises information associated with worker performance, skills and/or demographics, and the deadlines comprise internal deadlines, external deadlines, or metrics associated with the timing of the campaign; and
the information associated with historical tasks comprises completion time, stakeholders, documents, errors, and fees, the information associated with current tasks comprises stakeholders, documents and fees, and the information associated with the user metadata comprises processing rimes, processing errors and loads.

3. The computer-implemented method of claim 1, wherein the performing comprises, for the obtained inputs of the input obtaining process being received, parsing the receive inputs by task.

4. The computer-implemented method of claim 1, wherein the performing comprises computing risks, estimates, timelines, and/or targets.

5. The computer-implemented method of claim 1, wherein the generating comprises providing the generation task lists, and information on the point values associated with the task lists for a game.

6. The computer-implemented method of claim 1, wherein the generating comprises generating a contest recommendation based on the timing of the campaign, the team composition, and goals recommended as an outcome of the campaign based on one or more metrics of performance.

7. The computer-implemented method of claim 1, further comprising generated one or more interfaces for the user to visual a scoreboard of the point values or details of a score associated with the point values.

8. A non-transitory computer readable medium including instructions executable on a processor, the instructions comprising:
obtaining an input associated with historical information, deadlines, and user-related information, or information associated with historical tasks, current tasks and user metadata;
performing a calculation on the input to generate an output; and
based on the output, generating a timing of a campaign and a team composition, or task lists and point values.

9. The non-transitory computer readable medium of claim 8, wherein,
the historical information comprises past campaign results, the user-related information comprises information associated with worker performance, skills and/or demographics, and the deadlines comprise internal deadlines, external deadlines, or metrics associated with the timing of the campaign; and
the information associated with historical tasks comprises completion time, stakeholders, documents, errors, and fees, the information associated with current tasks comprises stakeholders, documents and fees, and the information associated with the user metadata comprises processing rimes, processing errors and loads.

10. The non-transitory computer readable medium of claim 8, wherein the performing comprises, for the obtained inputs of the input obtaining process being received, parsing the receive inputs by task.

11. The non-transitory computer readable medium of claim 8, wherein the performing comprises computing risks, estimates, timelines, and/or targets.

12. The non-transitory computer readable medium of claim 8, wherein the generating comprises providing the generation task lists, and information on the point values associated with the task lists for a game.

13. The non-transitory computer readable medium of claim 8, wherein the generating comprises generating a contest recommendation based on the timing of the campaign, the team composition, and goals recommended as an outcome of the campaign based on one or more metrics of performance.

14. The non-transitory computer readable medium of claim 8, further comprising generated one or more interfaces for the user to visual a scoreboard of the point values or details of a score associated with the point values.

15. A system, comprising:
a processor obtaining an input associated with historical information, deadlines, and user-related information, or information associated with historical tasks, current tasks and user metadata;
the processor performing a calculation on the input to generate an output; and
based on the output, the processor generating a timing of a campaign and a team composition, or task lists and point values.

16. The system of claim 15, wherein,
the historical information comprises past campaign results, the user-related information comprises information associated with worker performance, skills and/or demographics, and the deadlines comprise internal deadlines, external deadlines, or metrics associated with the timing of the campaign; and
the information associated with historical tasks comprises completion time, stakeholders, documents, errors, and fees, the information associated with current tasks comprises stakeholders, documents and fees, and the information associated with the user metadata comprises processing rimes, processing errors and loads.

17. The system of claim 15, wherein the performing comprises, for the obtained inputs of the input obtaining process being received, parsing the receive inputs by task, and further comprising generated one or more interfaces for the user to visual a scoreboard of the point values or details of a score associated with the point values.

18. The system of claim 15, wherein the performing comprises computing risks, estimates, timelines, and/or targets.

19. The system of claim 15, wherein the generating comprises providing the generation task lists, and information on the point values associated with the task lists for a game.

20. The system of claim 15, wherein the generating comprises generating a contest recommendation based on the timing of the campaign, the team composition, and goals recommended as an outcome of the campaign based on one or more metrics of performance.
